(19) United States
(12) Patent Application Publication
(10) Pub. No.: US 2026/0349910 A1
(43) Pub. Date: Nov. 5, 2026

(54) METHOD AND APPARATUS FOR DETECTING ASSEMBLER BUG

(71) Applicant: Korea Advanced Institute of Science and Technology, Daejeon (KR)

(72) Inventors: Sang Kil CHA, Daejeon (KR); Hyungseok KIM, Daejeon (KR); Soomin KIM, Daejeon (KR); Jungwoo LEE, Daejeon (KR)

(21) Appl. No.: 19/641,659

(22) Filed: Apr. 8, 2026

(30) Foreign Application Priority Data
Apr. 8, 2025 (KR) 10-2025-0045619

(51) Int. Cl. G06F 11/3668

(52) U.S. Cl. CPC G06F 11/3692; G06F 11/3684

(57) ABSTRACT

An assembler bug detection method according to a first aspect of one embodiment comprises providing an assembly instruction to each of a plurality of assemblers to obtain a machine code conversion result and error information from each of the plurality of assemblers; generating a grammar employed in each of the plurality of assemblers based on the machine code conversion result and the error information; generating a test assembly instruction for detecting an assembler having a bug from among the plurality of assemblers based on the grammar; and detecting the bug in at least one assembler based on a result of converting the test assembly instruction into machine code by the at least one assembler among the plurality of assemblers.

### CROSS REFERENCE TO RELATED APPLICATION

The present application claims priority to Korean Patent Application No. 10-2025-0045619, filed on Apr. 8, 2025, the entire contents of which are incorporated here for all purposes by this reference.

### TECHNICAL FIELD

The present disclosure relates to a method and apparatus for detecting an assembler bug.

### BACKGROUND ART

Machine code refers to binary instruction code directly understandable and executable by a CPU (central processing unit) of a computer device.

Assembly language is a low-level programming language corresponding on one-to-one with machine code, and is a form expressing machine code using symbols and abbreviations for humans to read. Different assembly languages may be used for different CPU architectures.

An assembler is software converting assembly language into machine code form, and may be used to convert assembly instruction into machine code during a compile process converting source code written in a programming language into machine code.

Meanwhile, an assembler bug may refer to an error in which an assembler incorrectly interprets assembly code or generates incorrect machine code. Since such an assembler bug may cause errors in a compiled binary program, a systematic test method for finding the assembler bug is required, but a test method targeting the assembler has not been proposed.

Furthermore, in order to perform a test on an assembler, a grammar rule for an assembly language may be required. However, the grammar of an assembly language allowable by each assembler is different and is not documented, causing difficulty in defining the grammar of an assembly language allowable by each assembler.

### DISCLOSURE

### Technical Problem

Embodiments provide a technique for determining a grammar corresponding to an assembler, and detecting a bug in the assembler based on the grammar.

However, the objects of the present disclosure are not limited to the above-mentioned objects, and other unmentioned objects will be clearly understood by those skilled in the art from the following description.

### Technical Solution

An assembler bug detection method according to a first aspect of the present disclosure includes providing an assembly instruction to each of a plurality of assemblers to obtain a machine code conversion result and error information from each of the plurality of assemblers; generating a grammar employed in each of the plurality of assemblers based on the machine code conversion result and the error information; generating a test assembly instruction for detecting an assembler having a bug from among the plurality of assemblers based on the grammar; and detecting the bug in at least one assembler based on a result of converting the test assembly instruction into machine code by the at least one assembler among the plurality of assemblers.

The grammar may include an opcode-operand combination between an opcode corresponding to a machine code opcode defined in a predetermined CPU (central processing unit) architecture and an operand corresponding to the opcode.

The test assembly instruction may be determined as at least one of an operand pair combination generated based on the number of operands allowable for the opcode, and a plurality of assembly instructions generated based on the opcode.

The grammar may be determined based on whether an error occurs by compiling the plurality of assembly instructions.

Generating the grammar may include generating an instruction being an opcode-operand combination between an opcode and an operand corresponding to the opcode; and removing a pseudo instruction that is unexecutable by a predetermined CPU from the instruction.

Removing the pseudo instruction may include converting the instruction into machine code using an assembler; disassembling the instruction converted into machine code to convert the instruction back into an assembly language; and determining the instruction as the pseudo instruction if the instruction and the instruction converted back into the assembly language are not identical.

In detecting the bug, the bug may be detected in a different manner depending on whether the test assembly instruction is allowable in a reference assembler different from the at least one assembler.

The test assembly instruction may be allowable in the reference assembler. At this time, detecting the bug may include converting the test assembly instruction into machine code using the at least one assembler; and converting the test assembly instruction into machine code using the reference assembler. Furthermore, the bug may be detected as a bug in the at least one assembler or the reference assembler as the test assembly instruction converted into machine code using the at least one assembler and the test assembly instruction converted into machine code using the reference assembler are different.

The test assembly instruction may not be allowable in the reference assembler. At this time, detecting the bug may include converting the test assembly instruction into machine code using the at least one assembler; and disassembling the test assembly instruction converted into machine code to convert the test assembly instruction back into an assembly language. Furthermore, the bug may be detected as a bug in the at least one assembler if the test assembly instruction and the reconverted assembly instruction are different, and detected as a bug in the reference assembler if the test assembly instruction and the reconverted assembly instruction are identical.

An assembler bug detection apparatus according to a second aspect of the present disclosure comprises a memory storing at least one instruction, and a processor, and as the at least one instruction is executed by the processor, the assembler bug detection apparatus provides an assembly instruction to each of a plurality of assemblers to obtain a machine code conversion result and error information from each of the plurality of assemblers, generates a grammar employed in each of the plurality of assemblers based on the machine code conversion result and the error information, generates a test assembly instruction for detecting an assembler having a bug from among the plurality of assemblers based on the grammar, and detects the bug in at least one assembler based on a result of converting the test assembly instruction into machine code by the at least one assembler among the plurality of assemblers.

A non-transitory computer-readable storage medium storing at least one computer-executable instruction is provided according to a third aspect of the present disclosure, wherein the at least one instruction, when executed by a processor, causes the processor to perform a method comprising providing an assembly instruction to each of a plurality of assemblers to obtain a machine code conversion result and error information from each of the plurality of assemblers; generating a grammar employed in each of the plurality of assemblers based on the machine code conversion result and the error information; generating a test assembly instruction for detecting an assembler having a bug from among the plurality of assemblers based on the grammar; and detecting the bug in at least one assembler based on a result of converting the test assembly instruction into machine code by the at least one assembler among the plurality of assemblers.

### Advantageous Effects

According to the above embodiments, a grammar allowable by an assembler may be effectively inferred. Furthermore, bugs of various assemblers may be detected using such grammar.

The effects obtainable in the present disclosure are not limited to the effects mentioned above, and other effects not mentioned will be clearly understood by those skilled in the art to which the present disclosure pertains from the following description.

### BRIEF DESCRIPTION OF DRAWINGS

FIG. 1 is a block diagram illustrating an assembler bug detection apparatus according to the second aspect.

FIG. 2 is a block diagram illustrating a function of an assembler bug detection program.

FIG. 3 is a flowchart illustrating an assembler bug detection method according to the first aspect.

FIG. 4 is an exemplary diagram illustrating a structure of a tool (AsFuzzer) performing an assembler bug detection method according to the first aspect.

FIG. 5 is a table illustrating operand types allowable in an x86-64 CPU architecture.

FIG. 6 is a table illustrating a result of measuring time taken to infer a grammar allowable by each assembler.

FIG. 7 is a table illustrating a ratio of valid instructions among instructions generated through each assembler.

FIG. 8 is a graph illustrating a ratio of a grammar inferred by each assembler.

FIG. 9 is a table illustrating types of bugs detected according to an assembler bug detection method according to an embodiment.

### DETAILED DESCRIPTION OF THE INVENTION

Advantages and features of the present disclosure, and methods of achieving them will become clear with reference to embodiments described below in detail in conjunction with the accompanying drawings. However, the present disclosure is not limited to the embodiments disclosed below, but may be implemented in various different forms, and the present embodiments are provided to complete the disclosure of the present disclosure, and to completely inform those skilled in the art of the scope of the disclosure, and the present disclosure is defined by the scope of the claims.

In describing the embodiments of the present disclosure, if it is determined a detailed description of a known function or configuration may unnecessarily obscure the gist of the present disclosure, then the detailed description thereof will be omitted. In addition, terms to be described later are terms defined in consideration of functions in the embodiments of the present disclosure, varying depending on the intention or custom of a user or operator. Therefore, the definition thereof should be made based on the contents throughout the present specification.

Terms used in the present specification will be briefly described, and the present disclosure will be described in detail.

The terms used in the present specification have been selected as general terms currently widely used as much as possible while considering the functions of the present disclosure, but this may vary depending on the intention of a technician working in the field, precedents, or the emergence of new technologies. In addition, in specific cases, there are terms arbitrarily selected by the applicant, and in this case, the meaning thereof will be described in detail in the corresponding description of the disclosure. Therefore, the terms used in the present disclosure should be defined based on the meaning of the terms and the contents throughout the present disclosure, rather than simple names of the terms.

Throughout the specification, if a part “includes” a certain element, then this means the part may further include other elements, rather than excluding other elements, unless specifically stated otherwise.

Furthermore, the term “unit” used in the specification refers to a software or hardware component such as an FPGA or an ASIC, and the “unit” performs certain roles. However, the “unit” is not limited to software or hardware. The “unit” may be stored in an addressable storage medium or executable by one or more processors. Therefore, as an example, the “unit” includes components such as software components, object-oriented software components, class components, and task components, processes, functions, attributes, procedures, subroutines, segments of program code, drivers, firmware, microcode, circuitry, data, databases, data structures, tables, arrays, and variables. Functions provided within components and “units” may be combined into a smaller number of components and “units” or further separated into additional components and “units”.

Hereinafter, embodiments of the present disclosure will be described in detail with reference to the accompanying drawings so that those skilled in the art to which the present disclosure pertains may easily practice them.

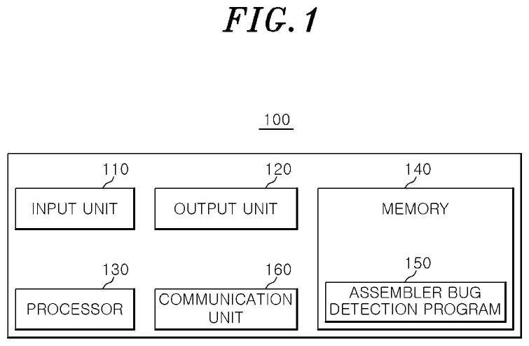

FIG. 1 is a block diagram illustrating an assembler bug detection apparatus according to the second aspect.

As illustrated in FIG. 1, the assembler bug detection apparatus 100 may include an input unit 110, an output unit 120, a processor 130, a memory 140, or a communication unit 160.

Hereinafter, for convenience of description, an example in which the input unit 110, the output unit 120, the processor 130, the memory 140, or the communication unit 160 are included in the assembler bug detection apparatus 100 will be described, but the present disclosure is not limited thereto. That is, each unit component may be provided outside the assembler bug detection apparatus 100 to operate in a manner of interacting with the assembler bug detection apparatus 100.

The input unit 110 may include a user interface receiving commands, information, and the like used for controlling the assembler bug detection apparatus 100. Furthermore, the input unit 110 may be a hardware device (for example, a keyboard, a mouse, a touch pad, and the like) receiving commands, information, and the like used for controlling the assembler bug detection apparatus 100 directly.

In an embodiment, the input unit 110 may receive information used for an assembler bug detection method from a user. Specifically, the user may input information including an opcode, an operand corresponding to the opcode, an assembler, a predetermined CPU architecture, a bug detection execution time, or the number of test assembly instructions through the input unit 110.

The output unit 120 may provide information including the opcode, the operand corresponding to the opcode, the assembler, the predetermined CPU architecture, the bug detection execution time, the number of test assembly instructions, or a bug detection result to the user as visual information through an interface.

The processor 130 may generally control operations of the assembler bug detection apparatus 100 in order to perform the present disclosure.

The processor 130 may load an assembler bug detection program 150 and information used for executing the assembler bug detection program 150 from the memory 140 to execute the assembler bug detection program 150.

The processor 130 may control the assembler bug detection apparatus 100 to store data received from an external device through the communication unit 160 in the memory 140.

Furthermore, the processor 130 may control the assembler bug detection apparatus 100 to transmit and receive information including the opcode, the operand corresponding to the opcode, the assembler, the predetermined CPU architecture, the bug detection execution time, the number of test assembly instructions, or the bug detection result with the external device through the communication unit 160.

The processor 130 may refer to a processing device such as a microprocessor, a CPU (central processing unit), a GPU (graphic processing unit), a processor core, a multiprocessor, an ASIC (application-specific integrated circuit), an FPGA (field programmable gate array), or an MCU (micro controller unit), but is not limited to the above-described embodiment.

The memory 140 may store the assembler bug detection program 150 and information used for executing the assembler bug detection program 150. Furthermore, the memory 140 may store a processing result by the processor 130.

The assembler bug detection program 150 may refer to software including instructions programmed to perform the method according to the present disclosure.

The memory 140 may store information including the opcode, the operand corresponding to the opcode, the assembler, the predetermined CPU architecture, the bug detection execution time, the number of test assembly instructions, or the bug detection result. Furthermore, the memory 140 may store information received from the external device through the communication unit 160.

The memory 140 may refer to a non-transitory computer-readable storage medium such as magnetic media such as a hard disk, a floppy disk, and a magnetic tape, optical media such as a CD-ROM and a DVD, magneto-optical media such as a floptical disk, random access memory such as a DRAM (dynamic random access memory) and an SRAM (static random access memory), and a hardware device specially programmed to store and execute program instructions such as a flash memory, but is not limited to the above-described embodiment.

The communication unit 160 may be a wireless communication module performing wireless communication by adopting a communication method such as CDMA, GSM, W-CDMA, TD-SCDMA, WiBro, LTE, EPC, 5G, wireless lan, wi-fi, bluetooth, zigbee, WFD (wi-fi direct), UWB (ultra wide band), IrDA (infrared data association), BLE (bluetooth low energy), or NFC (near field communication), but is not limited to the above-described embodiment.

Furthermore, the information inputted and outputted through the input unit 110 and the output unit 120, the information stored in the memory 140, and the information transmitted and received through the communication unit 160 include all information related to the present disclosure, and are not limited to the above-described embodiment.

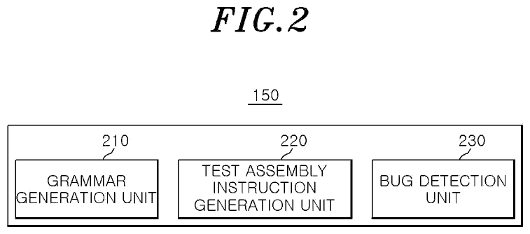

Functions or operations of the assembler bug detection program 150 will be described in detail with reference to FIG. 2.

FIG. 2 is a block diagram illustrating a function of an assembler bug detection program.

As illustrated in FIG. 2, the assembler bug detection program 150 may include a grammar generation unit 210, a test assembly instruction generation unit 220, and a bug detection unit 230. The grammar generation unit 210, the test assembly instruction generation unit 220, and the bug detection unit 230 are exemplarily dividing the functions of the assembler bug detection program 150, and are not limited thereto.

Depending on embodiments, functions of each of the grammar generation unit 210, the test assembly instruction generation unit 220, and the bug detection unit 230 may be merged/separated, and may be implemented as a series of instructions included in at least one program.

Each of the grammar generation unit 210, the test assembly instruction generation unit 220, and the bug detection unit 230 is stored in the memory 140, and may perform functions described below if executed by the processor 130 described above.

First, the grammar generation unit 210 may generate the grammar employed in each of a plurality of assemblers. Specifically, the grammar generation unit 210 may provide an assembly instruction to each of the plurality of assemblers to generate a machine code conversion result and error information from each of the plurality of assemblers.

An assembler is software converting assembly language into machine code form, and may be used to convert assembly code into machine code during a compile process converting source code written in a programming language into machine code.

Assembly language is a low-level programming language corresponding one-to-one with machine code, and is a form expressing machine code using symbols and abbreviations for humans to read. Different assembly languages may be used for different CPU architectures.

In an assembly language, each instruction may be composed of “opcode+operand”. At this time, the opcode refers to a unique code indicating the type of instruction executed by a CPU, and the CPU may interpret the opcode and perform operations accordingly. Furthermore, the operand may refer to a target (value, register, or memory address) of the operation performed by the opcode. For example, in the case of a “push 4” instruction in x86-64 assembly, “push” may refer to the opcode, and “4” may refer to a first operand. As another example, in the case of a “mov rax, 1” instruction, “mov” may refer to the opcode, “rax” may refer to a first operand, and “1” may refer to a second operand.

The above-described opcode and operand may include an assembly language, and such opcode and operand may correspond to an ISA (instruction set architecture) supported by a predetermined CPU architecture.

Grammar refers to the grammar of an assembly language supported by a specific assembler, and may include an opcode allowable by the specific assembler and an operand format therefor. That is, the grammar may refer to an operand combination allowable for each opcode. For example, the grammar may include an opcode list allowable by an assembler, the number of operands allowable for each opcode, and possible operand types and formats for each number of operands.

Meanwhile, an assembler bug may refer to an error in which an assembler incorrectly interprets assembly code or generates incorrect machine code. As incorrect machine code is generated due to such an assembler bug, a program collision and security vulnerability may be induced, a compiled program may operate differently than expected, and an outputted binary code may cause a problem of operating differently than expected, thereby causing a problem making debugging difficult.

The CPU architecture is a design architecture defining a method and structure for the CPU to process an instruction, and may include an instruction set, a register structure, or a memory management method defining a machine code opcode and an operand format executable by the CPU. For example, the CPU architecture may be for at least one of x86, x86-64, ARM, AArch64, MIPS, and RISCV64, but is not limited thereto.

The grammar may include an opcode-operand combination between an opcode corresponding to a machine code opcode defined in a predetermined CPU architecture and an operand corresponding to the opcode.

Even for the same CPU, the number of allowable operands may be different for each opcode. For example, a PUSH opcode may require 1 operand, a MOV instruction may require 2 operands, and an IMUL opcode may require 1 to 3 operands. Furthermore, the maximum limit of the number of operands may be determined according to the CPU architecture.

The grammar may be determined based on whether an error occurs by performing compiling on an operand pair combination generated based on the number of operands allowable for the opcode and a plurality of assembly instructions generated based on the opcode.

The grammar generation unit 210 may generate an instruction being an opcode-operand combination between an opcode and an operand corresponding to the opcode. Furthermore, the grammar generation unit 210 may remove a pseudo instruction that is unexecutable by a predetermined CPU from the instruction. The pseudo instruction is an assembly instruction not directly converted into actual machine code, and may refer to an instruction that is unexecutable directly by the CPU.

Specifically, the grammar generation unit 210 may convert the instruction into machine code using the assembler, disassemble the instruction converted into machine code to convert the instruction back into an assembly language, and determine the instruction as the pseudo instruction if the instruction and the instruction converted back into the assembly language are not identical.

Disassembling may refer to a process of converting machine code (binary code) back into assembly code. That is, through a disassembling process, pure machine code (opcode+operand) executable by the CPU may be converted into human-readable assembly language.

The test assembly instruction generation unit 220 may generate a test assembly instruction for detecting an assembler having a bug from among the plurality of assemblers in consideration of the grammar generated by the grammar generation unit 210.

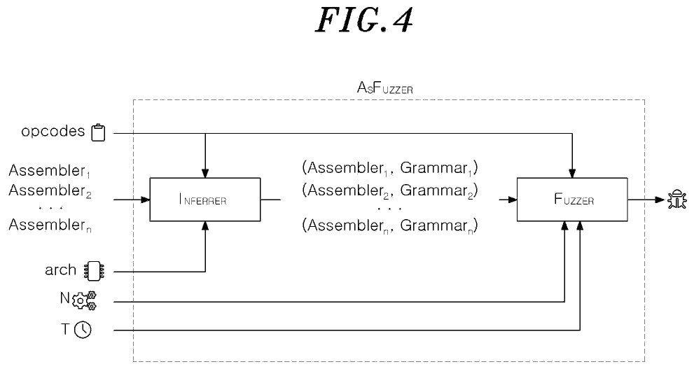

The test assembly instruction may be determined as at least one of an operand pair combination generated based on the number of operands allowable for the opcode, and a plurality of assembly instructions generated based on the opcode. At this time, the number of operands allowable for the opcode may be determined based on an assembler error message. Furthermore, the operand pair combination may be determined based on the number of such operands, and a detailed description thereof will be provided with reference to FIG. 4.

The bug detection unit 230 may detect a bug in at least one assembler based on a result of converting the test assembly instruction into machine code by the at least one assembler among the plurality of assemblers.

The bug detection unit 230 may detect the bug in a different manner depending on whether the test assembly instruction is allowable in a reference assembler different from the at least one assembler.

In one embodiment, if the test assembly instruction is allowable in the reference assembler, then the bug detection unit 230 may convert the test assembly instruction into machine code using the at least one assembler, and convert the test assembly instruction into machine code using the reference assembler. At this time, the bug may be detected as a bug in the at least one assembler or the reference assembler as the test assembly instruction converted into machine code using the at least one assembler and the test assembly instruction converted into machine code using the reference assembler are different.

In another embodiment, if the test assembly instruction is not allowable in the reference assembler, then the bug detection unit 230 may convert the test assembly instruction into machine code using the at least one assembler, and disassemble the test assembly instruction converted into machine code to convert the test assembly instruction back into an assembly language. At this time, the bug may be detected as a bug in the at least one assembler if the test assembly instruction and the reconverted assembly instruction are different, and detected as a bug in the reference assembler if they are identical.

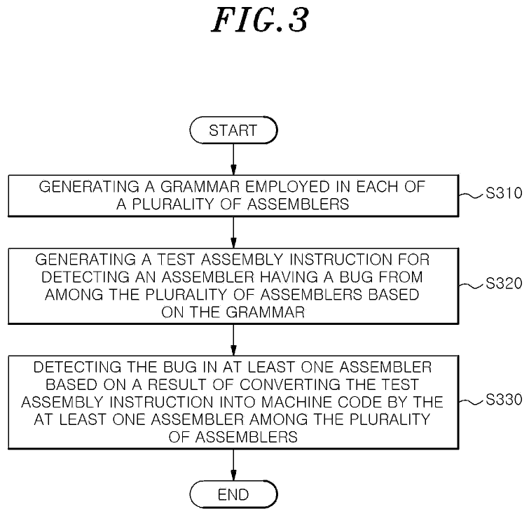

FIG. 3 is a flowchart illustrating an assembler bug detection method according to the first aspect. Here, the method illustrated in FIG. 3 may be executed by the assembler bug detection apparatus 100 illustrated in FIG. 1. In addition, the flowchart illustrated in FIG. 3 is merely an example, and depending on embodiments, each operation may be executed in an order different from that described in the flowchart, or operations not described in the flowchart may be additionally executed, or one or more of the operations described in the flowchart may not be executed.

As illustrated in FIG. 3, the assembler bug detection method according to an embodiment is performed by including generating the grammar employed in each of a plurality of assemblers S310, generating a test assembly instruction for detecting an assembler having a bug from among the plurality of assemblers in consideration of the grammar S320, and detecting a bug in at least one assembler based on a result of converting the test assembly instruction into machine code by the at least one assembler among the plurality of assemblers S330.

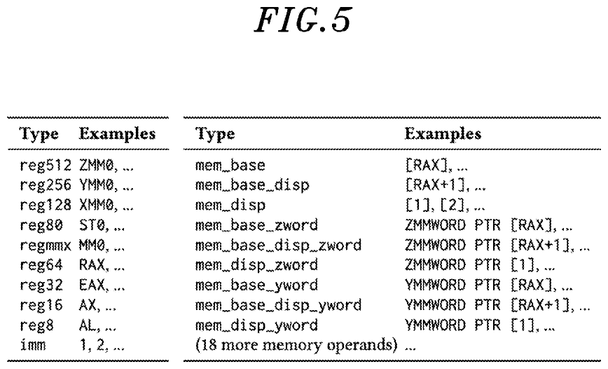

FIG. 4 is an exemplary diagram illustrating a structure of an assembler fuzzing tool (AsFuzzer) performing an assembler bug detection method according to the first aspect, and FIG. 5 is a table illustrating operand types allowable in an x86-64 CPU architecture.

In the present specification, a tool performing an assembler bug detection method according to an embodiment may be referred to as AsFuzzer. The assembler fuzzing tool is a fuzzing tool for detecting a bug, and may be a predetermined program finding a bug by performing differential testing on operations of assemblers. Here, the differential test may refer to a software testing technique finding errors by providing the same input to a plurality of assemblers and comparing output results.

Referring to FIG. 4, the assembler fuzzing tool may include an inference module (INFERRER) inferring grammar and a fuzzing module (FUZZER) detecting a bug using the inferred grammar. Hereinafter, operations of the inference module and the fuzzing module will be described in detail.

First, in the inference module, an error message outputted by an assembler may be used to infer grammar being an operand format allowable by the assembler. Here, the operand format, that is, the grammar, may include the number of operands, an operand type, or an operand addressing mode.

In an embodiment, the inference module may store or refer to an opcode set corresponding to a predetermined CPU architecture and a predetermined operand type set, generate a plurality of candidate assembly instructions for each assembler, and generate grammar information based on a result of executing these instructions.

The inference module may receive a CPU architecture (arch), an opcode list allowable in the CPU (opcodes), and a plurality of assemblers (Assembler₁, Assembler₂, . . . , Assembler_{N}) to perform a test. The inference module may infer an operand format allowable by each assembler for a given opcode. In the present specification, all operand formats for opcodes allowable by an assembler are referred to as grammar. The inference module may generate assembly grammar (Assembler₁, Assembler₂, . . . , Assembler_{N}) accommodated by each assembler (Grammar₁, Grammar₂, . . . , Grammar_{N}).

The inference module may generate all operand formats allowable in the CPU architecture in consideration of a predetermined operand type list as shown in FIG. 5.

Referring to FIG. 5, a left portion of the table illustrates registers and immediate operands, and a right portion illustrates examples usable in actual code for a memory referencing method. Here, the immediate operand may refer to an operand in a manner of directly inputting a constant such as a number or a memory address.

Referring back to FIG. 4, the inference module may infer the number of operands for each opcode. Specifically, the inference module may generate a plurality of candidate assembly instructions having different numbers of operands for each opcode, provide each candidate assembly instruction to a corresponding assembler, and determine an allowable operand number set for the opcode from generated error information.

In order to infer the number of operands possessed by an opcode, an assembler error message may be used. If the number of inputted operands is incorrect, then an assembler may output a predetermined error message. For example, in a GNU assembler, if the number of operands for an “add” instruction is incorrect, then an error message such as “Error: number of operands mismatch for ‘add’” may be outputted.

For a CPU architecture capable of using a maximum of n operands, the number of operands may be inferred using n+1 instructions. Specifically, the inference module may randomly generate instructions from 0 operands to n operands, and then perform an assembly process. For example, the inference module may generate “add”, “add RAX”, “add RAX, RAX”, “add RAX, RAX, RAX”, and “add RAX, RAX, RAX, RAX” instructions for an “add” opcode of x86-64, and analyze an error message of the assembler. The inference module may determine the number of operands of an instruction not including an operand error message is valid.

After inferring the number of operands for an opcode, the inference module may infer a valid operand format for each number of operands. In order to effectively infer all possible operand formats, in the present disclosure, operand types accommodated in each CPU architecture may be predetermined. FIG. 5 illustrates 37 predetermined operand types for an x86-64 architecture. In addition, different numbers of operand types may be defined for x86, ARM, AArch64, MIPS, and RISCV64. The number of operand types described above is merely an example, and is not limited thereto.

Referring back to FIG. 4, the inference module may select one instance among each operand type to generate an instruction to infer a valid operand format. If the number of operands is first determined, then an operand combination corresponding to the number of operands may be determined. For example, if there are 37 allowable operand types in an x86-64 CPU architecture, if the number of operands is 2, then calculable combinations are 37*37=1,369, and if the number of operands is 3, then calculable combinations may be 37*37*37=50,653. That is, if operand combinations are randomly generated in a state where the number of operands is not determined, then incorrect instructions may be generated, so unnecessary testing may be reduced by first determining the number of operands. Specifically, the inference module may generate 1,369 (=37×37) instruction combinations to infer an operand format of an “add” opcode having 2 operands in the x86-64 CPU architecture. Compiling may be performed on the generated instruction combinations, and instructions having an error may be identified with reference to line numbers in an error message.

Finally, the inference module may infer an operand format for an instruction without an error as valid.

In an embodiment, the inference module may exclude a pseudo instruction among instructions accommodated by an assembler. At this time, the inference module may perform disassembly on a machine code converted by the assembler, and identify the pseudo instruction by checking whether an opcode of a disassembled code is identical to an initial opcode. The inference module may determine a result excluding the pseudo instruction as grammar. In an embodiment, the inference module may generate a grammar table for each assembler including an allowable operand number and operand format mapped to an opcode for each assembler.

Next, the fuzzing module may receive pairs of each assembler generated by the inference module and grammar information as an input, generate a test assembly instruction based on the grammar information, and verify a machine code conversion result of the assembler for the generated test assembly instruction to detect a bug. Specifically, in the fuzzing module, testing for a predetermined assembler may be performed using the grammar generated in the inference module, and it may be compared whether different assemblers generate a consistent binary from the same assembly instruction to detect a bug. For example, if outputs of different assemblers are different for the same assembly instruction, the difference may indicate the assembler is highly likely to include a bug.

The fuzzing module may receive a plurality of assemblers (Assembler₁, Assembler₂, . . . , Assembler_{N}) and a plurality of assembly grammars (Grammar₁, Grammar₂, . . . , Grammar_{N}) accommodated by each assembler as a pair. Furthermore, the fuzzing module may receive an opcode list (opcodes), a testing execution time (T), and the number of instructions to be generated in each testing (N). The fuzzing module may detect a bug of an assembler by repeatedly performing differential testing based on the received information.

In an embodiment, the fuzzing module may determine whether another assembler allows the same operand format for a selected opcode, and perform different verification procedures depending on whether the same operand format is allowed or not allowed.

First, for each differential testing, the fuzzing module may randomly select an opcode, and randomly select an operand format allowable by an arbitrary assembler A. The fuzzing module may randomly generate an assembly instruction i according to the inputted number of instructions (N) with reference to the selected opcode and operand format, and generate a binary i, using the assembler A.

The fuzzing module may select another assembler B to check whether the assembler B accommodates the instruction i. If the assembler B may accommodate the instruction i, then the fuzzing module may generate a binary b_{B} using the assembler B. The fuzzing module may compare b_{A} and b_{B} to check whether there is a difference.

If the assembler B does not accommodate the instruction i, then the fuzzing module may generate a disassembly result i′ for b_{A} using a predetermined disassembly tool (eg, GNU objdump), and compare i and i′ to check whether there is a difference. If a difference is found as a result of checking, then the fuzzing module may report it as a bug. Such testing may be repeatedly performed for N seconds. Summarizing the testing described above, it may be represented as the following table.

TABLE 1

| | | Assembler having |
|---|---|---|
| Situation | Analysis | bug possibility |
| b_{A} ≠ b_{B} | A and B generate different conversion | A or B (further |
| | results | analysis required) |
| i ≠ b_{B} | Disassembling conversion result of A | A |
| | differs from initial instruction | |
| i = i′ | Conversion of A has no error, but B | B |
| | rejects i | |

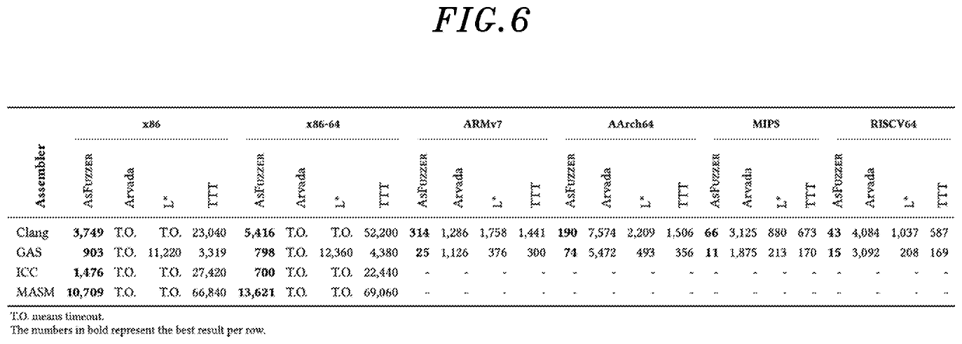

FIG. 6 is a table illustrating a result of measuring time taken to infer a grammar allowable by each assembler. Assemblers used for comparative evaluation for assembler bug detection according to the present disclosure are as follows.
Clang-integrated assembler v16.0.0 (Clang)
GNU assembler v2.41 (GAS)
Intel's assembler v2021.8.0 (ICC)
Microsoft macro assembler v14.37.32824.0 (MASM)

Furthermore, in the comparative evaluation for assembler bug detection according to the present disclosure of FIGS. 6 to 8, evaluation was performed on x86, x86-64, ARMv7, AArch64, MIPS, and RISCV64 CPU architectures.

Conventional grammar inference tools were used to measure the time taken to infer the grammar allowable by each assembler of FIG. 6, and specifically, Arvada, a context-free language inference tool, and L* and TTT, which are regular language inference tools, were used.

Referring to FIG. 6, AsFuzzer performing the assembler bug detection method according to the present disclosure inferred the assembly grammar fastest in all cases. In the case of Arvada, it took a long time to infer the assembly grammar. In particular, for x86 and x86-64 assembly grammars, the results show grammar inference was not completed within 24 hours. As for L*, it may also be seen a timeout occurred in all assemblers except GAS for x86 and x86-64. TTT completed grammar inference for all assemblers within 24 hours, but it may be seen it shows a result 7.2 times slower on average than AsFuzzer.

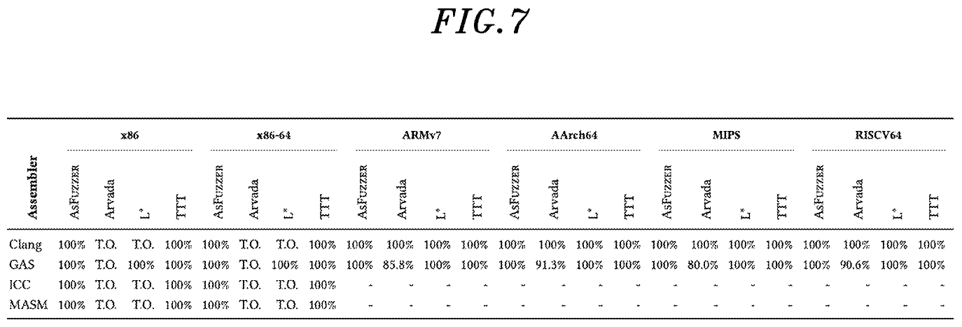

FIG. 7 is a table illustrating a ratio of valid instructions among instructions generated through each assembler.

Specifically, FIG. 7 illustrates a result of compiling 10,000 assembly instructions using the inferred grammar. Both AsFuzzer, TTT, and L* showed a success rate of 100%, but in the case of Arvada, it may be seen incorrect assembly instructions are generated.

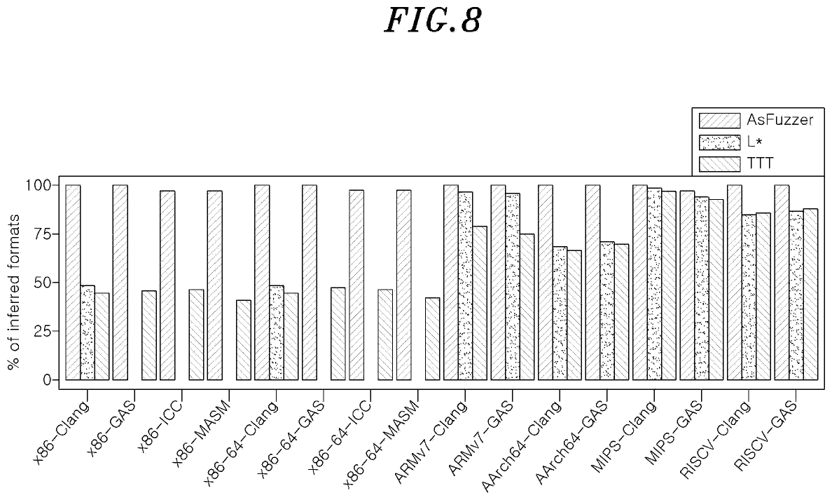

FIG. 8 is a graph illustrating a ratio of a grammar inferred by each assembler.

Specifically, since a ground truth for assembly grammar allowable by each assembler may not be created, a ratio of formats existing in the grammar inferred by each tool was measured based on a union of instruction formats inferred by each tool. As a result, it may be seen AsFuzzer inferred almost most instruction formats, while L* and TTT failed to infer a plurality of instruction formats.

The experimental results of FIGS. 6 to 8 show the assembly grammar may be effectively inferred through the assembler bug detection method according to the present disclosure.

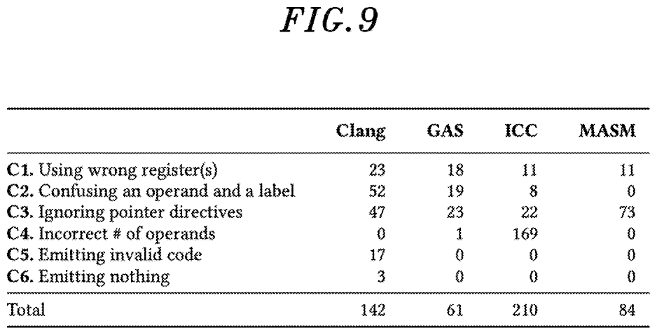

FIG. 9 is a table illustrating types of bugs detected according to an assembler bug detection method according to an embodiment.

As a result of conducting a bug detection experiment for a predetermined time using AsFuzzer performing the assembler bug detection method of the present disclosure, a total of 497 assembler bugs were detected.

Referring to FIG. 9, the assembler bug may include a bug changed to another register during assembly execution (using wrong register), a bug in which an assembler recognizes an operand as a label (confusing an operand and a label), a bug ignoring a pointer directive limiting a memory size (ignoring pointer directives), a bug generating an incorrect number of operands (incorrect number of operands), a bug generating an invalid binary code (emitting invalid code), or a bug in which an assembler does not output binary code (emitting nothing). As incorrect machine code is generated due to such an assembler bug, a program collision and security vulnerability may be induced, a compiled program may operate differently than expected, and an outputted machine code may cause a problem of operating differently than expected, thereby causing a problem making debugging difficult. As illustrated in FIG. 9, it may be seen various assembler bugs may be detected through the assembler bug detection method of the present disclosure.

As described above, according to an embodiment of the present disclosure, grammar allowable by an assembler may be effectively inferred. Furthermore, bugs of various assemblers may be detected using such grammar.

The above-described embodiments of the present disclosure may be implemented through various means. For example, embodiments of the present disclosure may be implemented by hardware, firmware, software, or a combination thereof.

Combinations of each block of the block diagrams and each operation of the flowcharts attached to the present disclosure may be executed by computer program instructions. Because these computer program instructions may be mounted on an encoding processor of a general-purpose computer, a special-purpose computer, or other programmable data processing equipment, the instructions executed through the encoding processor of the computer or other programmable data processing equipment generate means performing functions described in each block of the block diagram or each operation of the flowchart. Because these computer program instructions may also be stored in a computer-usable or computer-readable memory directing a computer or other programmable data processing equipment to implement a function in a specific manner, the instructions stored in the computer-usable or computer-readable memory may also produce an article of manufacture containing instruction means performing the function described in each block of the block diagram or each operation of the flowchart. Because the computer program instructions may also be mounted on a computer or other programmable data processing equipment, a series of operations are performed on the computer or other programmable data processing equipment to create a process executed by the computer, so that instructions performing the computer or other programmable data processing equipment may also provide operations for executing functions described in each block of the block diagram and each operation of the flowchart.

Furthermore, each block or each operation may represent a module, a segment, or a portion of code including one or more executable instructions for executing specified logical function(s). In some embodiments, functions mentioned in blocks or operations may occur out of order. For example, two blocks or operations illustrated in succession may in fact be executed substantially concurrently, or the blocks or operations may sometimes be executed in reverse order depending on corresponding functions.

The above description is merely an exemplary description of the technical spirit of the present disclosure, and various modifications and variations may be made by those skilled in the art without departing from the essential qualities of the present disclosure. Therefore, the embodiments disclosed in the present disclosure are not intended to limit the technical spirit of the present disclosure, but to describe, and the scope of the technical spirit of the present disclosure is not limited by these embodiments. The protection scope of the present disclosure should be interpreted by the claims below, and all technical ideas within the equivalent scope should be interpreted as being included in the scope of rights of the present disclosure.

What is claimed is:

1. The method for detecting an assembler bug to be performed by an assembler bug detection apparatus, the method comprising:
providing an assembly instruction to each of a plurality of assemblers to obtain a machine code conversion result and error information from each of the plurality of assemblers;
generating a grammar employed in each of the plurality of assemblers based on the machine code conversion result and the error information;
generating a test assembly instruction for detecting an assembler having a bug from among the plurality of assemblers based on the grammar; and
detecting the bug in at least one assembler based on a result of converting the test assembly instruction into machine code by the at least one assembler among the plurality of assemblers.

2. The method of claim 1, wherein the grammar includes an opcode-operand combination between an opcode corresponding to a machine code opcode defined in a predetermined CPU (central processing unit) architecture and an operand corresponding to the opcode.

3. The method of claim 2, wherein the test assembly instruction is determined as at least one of an operand pair combination generated based on the number of operands allowable for the opcode, and a plurality of assembly instructions generated based on the opcode.

4. The method of claim 3, wherein the grammar is determined based on whether an error occurs by compiling the plurality of assembly instructions.

5. The method of claim 1, wherein generating the grammar comprises: generating an instruction being an opcode-operand combination between an opcode and an operand corresponding to the opcode; and removing a pseudo instruction that is unexecutable by a predetermined CPU from the instruction.

6. The method of claim 5, wherein removing the pseudo instruction comprises: converting the instruction into machine code using an assembler of the plurality of assemblers; disassembling the instruction converted into the machine code to convert the instruction back into an assembly language; and determining the instruction as the pseudo instruction in response to the instruction and the instruction converted back into the assembly language not being identical.

7. The method of claim 1, wherein in detecting the bug, the bug is detected in a different manner depending on whether the test assembly instruction is allowable in a reference assembler different from the at least one assembler.

8. The method of claim 7, wherein the test assembly instruction is allowable in the reference assembler, and detecting the bug comprises: converting the test assembly instruction into machine code using the at least one assembler; and converting the test assembly instruction into machine code using the reference assembler, wherein the bug is detected as a bug in the at least one assembler or the reference assembler in response to the test assembly instruction converted into the machine code using the at least one assembler being different from the test assembly instruction converted into the machine code using the reference assembler.

9. The method of claim 7, wherein the test assembly instruction is not allowable in the reference assembler, and detecting the bug comprises: converting the test assembly instruction into machine code using the at least one assembler; and disassembling the test assembly instruction converted into machine code to convert the test assembly instruction back into an assembly language, wherein the bug is detected as a bug in the at least one assembler if the test assembly instruction and the reconverted assembly instruction are different, and as a bug in the reference assembler if the test assembly instruction and the reconverted assembly instruction are identical.

10. An assembler bug detection apparatus comprising: a memory storing at least one instruction; and a processor, wherein the processor executes the at least one instruction to: provide an assembly instruction to each of a plurality of assemblers to obtain a machine code conversion result and error information from each of the plurality of assemblers; generate a grammar employed in each of the plurality of assemblers based on the machine code conversion result and the error information; generate a test assembly instruction for detecting an assembler having a bug from among the plurality of assemblers based on the grammar; and detect the bug in at least one assembler based on a result of converting the test assembly instruction into machine code by the at least one assembler among the plurality of assemblers.

11. The apparatus of claim 10, wherein the grammar includes an opcode-operand combination between an opcode corresponding to a machine code opcode defined in a predetermined CPU (central processing unit) architecture and an operand corresponding to the opcode.

12. The apparatus of claim 11, wherein the test assembly instruction is determined as at least one of an operand pair combination generated based on the number of operands allowable for the opcode, and a plurality of assembly instructions generated based on the opcode.

13. The apparatus of claim 12, wherein the grammar is determined based on whether an error occurs by compiling the plurality of assembly instructions.

14. The apparatus of claim 10, wherein generating the grammar comprises: generating an instruction being an opcode-operand combination between an opcode and an operand corresponding to the opcode; and removing a pseudo instruction that is unexecutable by a predetermined CPU from the instruction.

15. The apparatus of claim 14, wherein removing the pseudo instruction comprises: converting the instruction into machine code using an assembler of the plurality of assemblers; disassembling the instruction converted into the machine code to convert the instruction back into an assembly language; and determining the instruction as the pseudo instruction in response to the instruction and the instruction converted back into the assembly language not being identical.

16. The apparatus of claim 10, wherein in detecting the bug, the bug is detected in a different manner depending on whether the test assembly instruction is allowable in a reference assembler different from the at least one assembler.

17. The apparatus of claim 16, wherein the test assembly instruction is allowable in the reference assembler, and detecting the bug comprises: converting the test assembly instruction into machine code using the at least one assembler; and converting the test assembly instruction into machine code using the reference assembler, wherein the bug is detected as a bug in the at least one assembler or the reference assembler in response to the test assembly instruction converted into the machine code using the at least one assembler being different from the test assembly instruction converted into the machine code using the reference assembler.

18. The apparatus of claim 16, wherein the test assembly instruction is not allowable in the reference assembler, and detecting the bug comprises: converting the test assembly instruction into machine code using the at least one assembler; and disassembling the test assembly instruction converted into machine code to convert the test assembly instruction back into an assembly language, wherein the bug is detected as a bug in the at least one assembler if the test assembly instruction and the reconverted assembly instruction are different, and as a bug in the reference assembler if the test assembly instruction and the reconverted assembly instruction are identical.

19. A non-transitory computer-readable storage medium storing at least one computer-executable instruction, wherein the at least one instruction, when executed by a processor, causes the processor to perform a method comprising: providing an assembly instruction to each of a plurality of assemblers to obtain a machine code conversion result and error information from each of the plurality of assemblers; generating a grammar employed in each of the plurality of assemblers based on the machine code conversion result and the error information; generating a test assembly instruction for detecting an assembler having a bug from among the plurality of assemblers based on the grammar; and detecting the bug in at least one assembler based on a result of converting the test assembly instruction into machine code by the at least one assembler among the plurality of assemblers.

20. The non-transitory computer-readable storage medium of claim 19, wherein the grammar includes an opcode-operand combination between an opcode corresponding to a machine code opcode defined in a predetermined CPU (central processing unit) architecture and an operand corresponding to the opcode.
